(19) United States
(12) Patent Application Publication
(10) Pub. No.: US 2025/0165302 A1
(43) Pub. Date: May 22, 2025

(54) MANAGING COMPUTING RESOURCES AT AN INFORMATION HANDLING SYSTEM

(71) Applicant: Dell Products L.P., Round Rock, TX (US)

(72) Inventors: Jacob Vincent Mink, Austin, TX (US); Balasingh Ponraj Samuel, Round Rock, TX (US)

(21) Appl. No.: 18/514,029

(22) Filed: Nov. 20, 2023

(51) Int. Cl. G06F 9/50

(52) U.S. Cl. CPC G06F 9/5072; G06F 9/5033

(57) ABSTRACT

Managing computing resources at an information handling system, including identifying, at a first time, i) neural hardware resources of the information handling system and ii) events supported at the information handling system; providing, to a client, data indicating the identified neural hardware resources and the identified events; receiving, from the client, data indicating a triggering condition for a particular model, the triggering condition indicating a particular event of the identified events and particular neural hardware resources of the identified neural hardware resources; registering the triggering condition; detecting, at a second time after the first time, an occurrence of the identified event at the information handling system; and in response to detecting the occurrence of the identified event, allocating the particular neural hardware resources to the client for execution of the particular model.

### BACKGROUND

### Field of the Disclosure

The disclosure relates generally to an information handling system, and in particular, managing computing resources at the information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Constant enablement of neural hardware resources at the information handling system can be taxing to the information handling system power and sustainability of the information handling system.

### SUMMARY

Innovative aspects of the subject matter described in this specification may be embodied in a method of managing computing resources at an information handling system, including identifying, at a first time, i) neural hardware resources of the information handling system and ii) events supported at the information handling system; providing, to a client, data indicating the identified neural hardware resources and the identified events; receiving, from the client, data indicating a triggering condition for a particular model, the triggering condition indicating a particular event of the identified events and particular neural hardware resources of the identified neural hardware resources; registering the triggering condition; detecting, at a second time after the first time, an occurrence of the identified event at the information handling system; and in response to detecting the occurrence of the identified event, allocating the particular neural hardware resources to the client for execution of the particular model.

Other embodiments of these aspects include corresponding systems, apparatus, and computer programs, configured to perform the actions of the methods, encoded on computer storage devices.

These and other embodiments may each optionally include one or more of the following features. For instance, de-registering, after execution of the particular model, the triggering condition. Receiving, from the client, a query for the data indicating the identified neural hardware resources and the identified events; and in response to receiving the query, providing, to the client, the data indicating the identified neural hardware resources and the identified events. In response to detecting the occurrence of the identified event: configuring the particular neural hardware resources; and allocating the particular neural hardware resources to the client. The events supported at the information handling system include system-level events, application-level events, and firmware-level events. The neural hardware resources of the information handling system includes neural processing unit (NPU), graphics processing unit (GPU), and gaussian and neural accelerator (GNA). Receiving, from the client, data indicating, for the particular model, the particular event of the identified events and the particular neural hardware resources of the identified neural hardware resources further includes, receiving, from the client, a signed plugin or proxy indicating, for the particular model, the particular event of the identified events and the particular neural hardware resources of the identified neural hardware resources.

Particular implementations of the subject matter described in this specification can be implemented so as to realize one or more of the following advantages. For example, power consumption can be improved, while reducing latency of activation of resources at the information handling system.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 illustrates a block diagram of an information handling system.

FIG. 3 illustrates a swim-lane diagram for managing computing resources of the information handling system.

FIG. 4 illustrates a method for managing computing resources of the information handling system.

### DESCRIPTION OF PARTICULAR EMBODIMENT(S)

This disclosure discusses methods and systems for managing computing resources of the information handling system. In short, a client can indicate for an occurrence of a particular event, a particular neural hardware resource for activation for use by the client. The client can register a triggering condition indicating such event and neural hardware resource. Thus, when the event is triggered, such neural hardware resource can be preemptively activated.

Specifically, this disclosure discusses a system and a method for managing computing resources at the information handling system, including identifying, at a first time, i) neural hardware resources of the information handling system and ii) events supported at the information handling system; providing, to a client, data indicating the identified neural hardware resources and the identified events; receiving, from the client, data indicating a triggering condition for a particular model, the triggering condition indicating a particular event of the identified events and particular neural hardware resources of the identified neural hardware resources; registering the triggering condition; detecting, at a second time after the first time, an occurrence of the identified event at the information handling system; and in response to detecting the occurrence of the identified event, allocating the particular neural hardware resources to the client for execution of the particular model.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such wires, optical fibers, microwaves, radio waves, and other electromagnetic and/or optical carriers; and/or any combination of the foregoing.

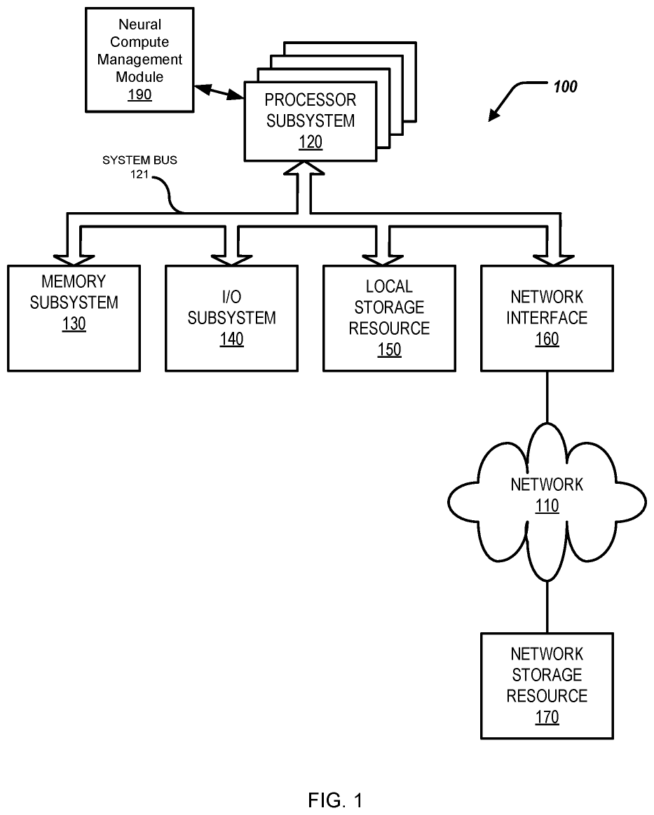

Particular embodiments are best understood by reference to FIGS. 1-4 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include a microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, or a camera, or another type of peripheral device.

Local storage resource 150 may comprise computer-readable media (e.g., hard disk drive, floppy disk drive, CD-ROM, and/or other type of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other type of rotating storage media, flash memory, EEPROM, and/or other type of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g. corporate) network. The network may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g. customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

The information handling system 100 can also include a neural compute management module 190. The neural compute management module 190 can be in communication with the processor subsystem 120, or included by the processor subsystem 120. In some examples, the neural compute management module 190 is included by an embedded controller (EC) of the information handling system 100.

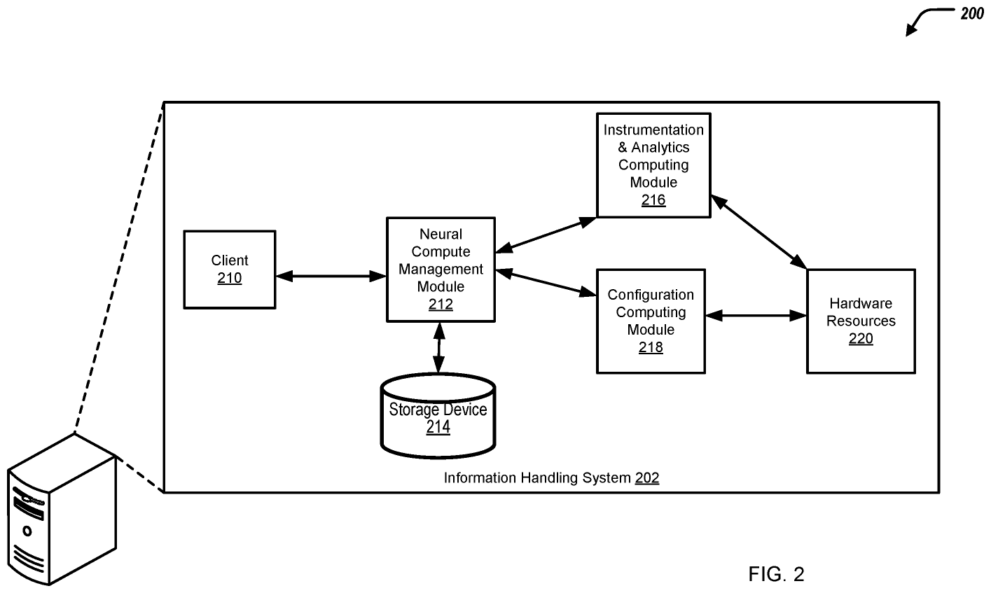

Turning to FIG. 2, FIG. 2 illustrates an environment 200 including an information handling system 202. The information handling system 202 can include a client 210, a neural compute management module 212, a storage device 214, an instrumentation and analytics computing module 216, a configuration computing module 218, and neural hardware resources 220. In some examples, the information handling system 202 is similar to, or includes, the information handling system 100 of FIG. 1. In some examples, the neural compute management module 212 is the same, or substantially the same, as the neural compute management module 190 of FIG. 1.

The client 210 can be in communication with the neural compute management module 212. The neural compute management model 212 can be in communication with the client 210, the storage device 214, the instrumentation and analytics computing module 216, and the configuration computing module 218. The instrumentation and analytics computing module 216 can be in communication with the neural compute management module 212, the configuration computing module 218, and the hardware resources 220. The configuration computing module 218 can be in communication with the neural compute management model 212 and the hardware resources 220. The hardware resources 220 can be in communication with the instrumentation and analytics computing module 216 and the configuration computing module 218.

The client 210 can include a computer-executable program, an artificial intelligence (AI) enabled computer-executable program, or the like.

In short, the client 210 can indicate for an occurrence of a particular event, a particular neural hardware resource 220 for activation for use by the client 210. The client 210 can register a triggering condition with the neural computing management module 212 indicating such event and neural hardware resource 220. Thus, when the event is triggered, the neural computing management module 212 can preemptively activate such neural hardware resource 220.

The neural compute management module 212 can identify, at a first time, the neural hardware resources 220 of the information handling system 202. For example, the neural compute management model 212 can identify the neural hardware resources 220 through the configuration computing module 218. In some examples, the neural hardware resources 220 can include a neural processing unit (NPU), a graphics processing unit (GPU), and/or a gaussian and neural accelerator (GNA). In some examples, the neural hardware sources 220 can include any type of distributed computing. Furthermore, the neural compute management model 212 can identify, at the first time, events supported at the information handling system 202. In some examples, the events supported at the information handling system 202 include system-level events, application-level events, and firmware-level events. For example, an event can include detection of dropped network packets during a web conference. For example, an event can include detection of execution of a processor intensive application. For example, an event can include detection of enablement of a device like a webcam.

The neural compute management model 212 can provide, to the client 210, data indicating the identified neural hardware resources 220 and the identified events that are supported at the information handling system 202. For example, the neural compute management model 212 can publish an inventory of the neural hardware sources 220 and publish an inventory of the events supported at the information handling system 202.

In some examples, the neural compute management model 212 can receive, from the client 210, a query for the data indicating the neural hardware resources 220 of the information handling system 202 and the events supported at the information handling system 202. The neural compute management model 212, in response to receiving the query, can provide, to the client 210, the data indicating the neural hardware resources 220 and the events supported at the information handling system 202.

The neural compute management model 212 can receive, from the client 210, data indicating a triggering condition for a particular model. For example, the particular model can be a machine learning model. The triggering condition can indicate a particular event of the events supported at the information handling system 202 and particular neural hardware resources of the neural hardware resources 220. In particular, the triggering condition can indicate that for a particular occurrence of an event that occurs at the information handling system 202, trigger allocation of the particular neural hardware resources of the neural hardware resources 220. The particular neural hardware resources 220 are implemented in the execution of the particular model. As described further in, by detecting the occurrence of the particular event, the particular neural hardware sources 220 are made available for execution of the particular model to provide greater efficiency and reduced latency.

In some examples, the neural compute management model 212 can receive, from the client 210, a signed plug-in or proxy indicating, for the particular model, the particular event and the particular neural hardware resources 220. For example, the neural compute management module 212 can receive the signed plugin or proxy over an authenticated remote procedure call (RPC).

In some example, the model and/or data associated with the model can be stored at the storage device 214 by the neural compute management module 212.

The neural compute management module 212, after receiving the triggering condition, can register the triggering condition. For example, the neural compute management module 212 can store data (e.g., at the storage device 214) indicating the triggering condition.

The neural compute management module 212 detects, at a second time after the first time, an occurrence of the identified event at the information handling system 202. For example, the neural compute management module 212 can determine that the identified event occurred through the instrumentation analytics computing module 216 and/or the configuration computing module 218. Detection of the occurrence of the event can include detection of a system-level event, an application-level event, or a firmware-level event. In some examples, the configuration computing module 218 and/or the information and analytics computing module 216 detects the occurrence of the event and provide data to the neural compute management module 212 indicating such occurrence automatically, or in response to a request from the neural compute management module 212.

The neural compute management module 212, in response to detecting the occurrence of the identified event, can allocate the particular neural hardware resource 220 to the client 210 for execution of the model. That is, the neural compute management module 212 can activate the particular neural hardware resource 220 preemptively so that the client 210 does not wait on resource initialization, thus increasing efficiency of execution of the model at the client 210. In short, the particular neural hardware resource 220 is “ready” when the client 210 needs to utilize the particular neural hardware resource 220 to execute the model.

In some examples, the neural compute management module 212, in response to detecting the occurrence of the identified event, configures the particular neural hardware resource 210 and allocates the particular neural hardware resource 220 to the client 210. Specifically, the neural compute management module 212 provides instructions to the configuration computing module 218 to preemptively configure the particular neural hardware resource 210 in response to detecting the occurrence of the identified event. The configuration computing module 218 then configures the particular neural hardware resource 220 such that the particular neural hardware resource 220 is allocated to the client 210.

The client 210 can then execute the model using the particular neural hardware resource 220. That is, the client 210 can execute the machine learning model, or AI model, using the particular neural hardware resource 220 with minimal latency.

In some examples, after the client 210 executes the model using the particular neural hardware resource 220, the neural compute management module 212 can de-register the triggering condition. For example, the neural compute management module 212 can remove references at the storage device 214 indicating the triggering condition.

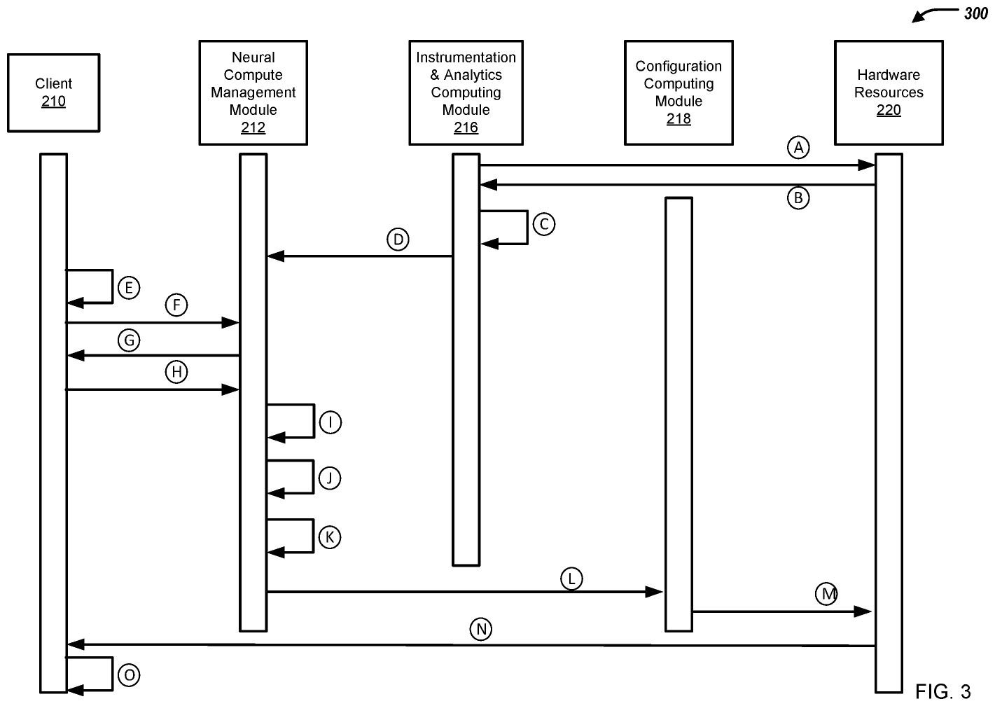

FIG. 3 illustrates a swim-lane diagram depicting selected elements of an embodiment of a method 300 for managing computing resources of the information handling system 200. The method 300 may be performed by the information handling system 100 and/or the information handling system 202, and with reference to FIGS. 1-2. It is noted that certain operations described in method 300 may be optional or may be rearranged in different embodiments.

The instrumentation and analytics computing module 216 identifies the neural hardware resources 220 and the capabilities thereof, at A; with such indication of the neural hardware resources 220 and the capabilities thereof returned, at B. The instrumentation and analytics computing module 216 determines supported events at the information handling system 202, at C. The instrumentation and analytics computing module 216 provides data indicating such supported events and neural hardware resources 220 to the neural compute management model 212, at D. The client 210 is initialized—e.g., the application is executed (“started”), at E. The client 210 provides a query to the neural compute management service 210 for the events that are supported at the information handling system 202 and the neural hardware resources 220 of the information handling system 202, at F. The neural compute management service 210 provides data indicating such supported events and supported neural hardware resources 220 to the client 210, at G. The client 210 provides data to the neural compute management service 210 indicating, for the model, data indicating the triggering condition for the model, at H. The triggering condition can indicate a particular event of the events supported at the information handling system 202 and particular neural hardware resources of the neural hardware resources 220. The neural compute management service 210 stores the model, at I. The neural compute management service 210 detects an occurrence of the event associated with the triggering condition, at J. The neural compute management service 210 can fetch the corresponding neural hardware resource 220 associated with the triggering condition, at K. The neural compute management service 210 can provide data to the configuration computing module 218 to preemptively configure the particular neural hardware resource 220, at L. The configuration computing module 218 can preemptively apply/allocate the particular neural hardware service 220, at M. The particular neural hardware resource 220 is allocated to the client 210 and is ready for execution of the particular model by the client 210, at N. The client 210 executes the particular model using the allocated neural hardware resources 220, at O.

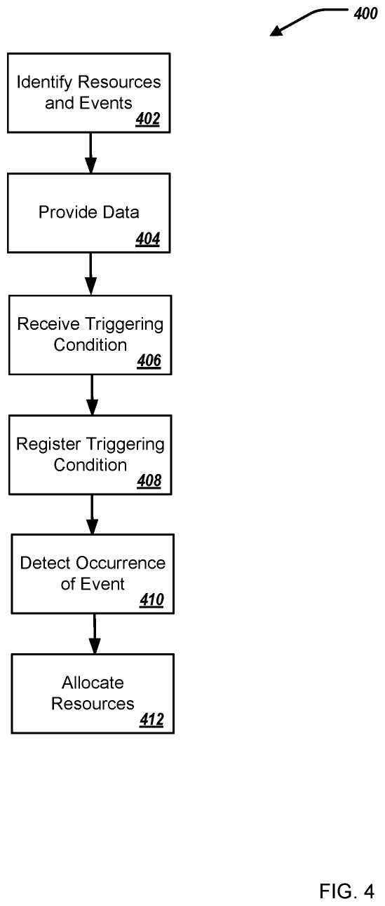

FIG. 4 illustrates a flowchart depicting selected elements of an embodiment of a method 400 for managing computing resources of the information handling system 200. The method 400 may be performed by the information handling system 100, the information handling system 202 and/or the neural compute management module 212, and with reference to FIGS. 1-2. It is noted that certain operations described in method 400 may be optional or may be rearranged in different embodiments.

The neural compute management module 212 can identify, at a first time, the neural hardware resources 220 of the information handling system 202 and events supported at the information handling system 202, at 402. The neural compute management model 212 can provide, to the client 210, data indicating the identified neural hardware resources 220 and the identified events that are supported at the information handling system 202, at 404. The neural compute management model 212 can receive, from the client 210, data indicating a triggering condition for a particular model, at 406. The triggering condition can indicate a particular event of the events supported at the information handling system 202 and particular neural hardware resources of the neural hardware resources 220. The neural compute management module 212 can register the triggering condition, at 408. The neural compute management module 212 detects, at a second time after the first time, an occurrence of the identified event at the information handling system 202, at 410. The neural compute management module 212, in response to detecting the currents of the identified event, can allocate the particular neural hardware resource 220 to the client 210 for execution of the model, at 412.

In an use case, a user can be conducting an video teleconference (client 210) using the information handling system 202. The client 210 (video teleconferencing application) can indicate for an event such as network packet loss during the video teleconference, a neural hardware resource to compensate for such network packet loss. The neural computing management module 212 can detect such packet loss, and automatically configure a NPU to enhance the audio for the video teleconference without adding latency or consuming additional power.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated other-wise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A computer-implemented method of managing computing resources at an information handling system, including:
identifying, at a first time, i) neural hardware resources of the information handling system and ii) events supported at the information handling system;
providing, to a client, data indicating the identified neural hardware resources and the identified events;
receiving, from the client, data indicating a triggering condition for a particular model, the triggering condition indicating a particular event of the identified events and particular neural hardware resources of the identified neural hardware resources;
registering the triggering condition;
detecting, at a second time after the first time, an occurrence of the identified event at the information handling system; and
in response to detecting the occurrence of the identified event, allocating the particular neural hardware resources to the client for execution of the particular model.

2. The computer-implemented method of claim 1, further including:
de-registering, after execution of the particular model, the triggering condition.

3. The computer-implemented method of claim 1, further including:
receiving, from the client, a query for the data indicating the identified neural hardware resources and the identified events; and
in response to receiving the query, providing, to the client, the data indicating the identified neural hardware resources and the identified events.

4. The computer-implemented method of claim 1, further including:
in response to detecting the occurrence of the identified event:
configuring the particular neural hardware resources; and
allocating the particular neural hardware resources to the client.

5. The computer-implemented method of claim 1, wherein the events supported at the information handling system include system-level events, application-level events, and firmware-level events.

6. The computer-implemented method of claim 1, wherein the neural hardware resources of the information handling system includes neural processing unit (NPU), graphics processing unit (GPU), and gaussian and neural accelerator (GNA).

7. The computer-implemented method of claim 1, wherein receiving, from the client, data indicating, for the particular model, the particular event of the identified events and the particular neural hardware resources of the identified neural hardware resources further includes, receiving, from the client, a signed plugin or proxy indicating, for the particular model, the particular event of the identified events and the particular neural hardware resources of the identified neural hardware resources.

8. An information handling system comprising a processor having access to memory media storing instructions executable by the processor to perform operations, comprising:
identifying, at a first time, i) neural hardware resources of the information handling system and ii) events supported at the information handling system;
providing, to a client, data indicating the identified neural hardware resources and the identified events;
receiving, from the client, data indicating a triggering condition for a particular model, the triggering condition indicating a particular event of the identified events and particular neural hardware resources of the identified neural hardware resources;
registering the triggering condition;
detecting, at a second time after the first time, an occurrence of the identified event at the information handling system; and
in response to detecting the occurrence of the identified event, allocating the particular neural hardware resources to the client for execution of the particular model.

9. The information handling system of claim 8, the operations further including:
de-registering, after execution of the particular model, the triggering condition.

10. The information handling system of claim 8, the operations further including:
receiving, from the client, a query for the data indicating the identified neural hardware resources and the identified events; and
in response to receiving the query, providing, to the client, the data indicating the identified neural hardware resources and the identified events.

11. The information handling system of claim 8, the operations further including:
in response to detecting the occurrence of the identified event:
configuring the particular neural hardware resources; and
allocating the particular neural hardware resources to the client.

12. The information handling system of claim 8, wherein the events supported at the information handling system include system-level events, application-level events, and firmware-level events.

13. The information handling system of claim 8, wherein the neural hardware resources of the information handling system includes neural processing unit (NPU), graphics processing unit (GPU), and gaussian and neural accelerator (GNA).

14. The information handling system of claim 8, wherein receiving, from the client, data indicating, for the particular model, the particular event of the identified events and the particular neural hardware resources of the identified neural hardware resources further includes, receiving, from the client, a signed plugin or proxy indicating, for the particular model, the particular event of the identified events and the particular neural hardware resources of the identified neural hardware resources.

15. A non-transitory computer-readable medium storing software comprising instructions executable by one or more computers which, upon such execution, cause the one or more computers to perform operations comprising:
identifying, at a first time, i) neural hardware resources of the information handling system and ii) events supported at the information handling system;
providing, to a client, data indicating the identified neural hardware resources and the identified events;
receiving, from the client, data indicating a triggering condition for a particular model, the triggering condition indicating a particular event of the identified events and particular neural hardware resources of the identified neural hardware resources;
registering the triggering condition;
detecting, at a second time after the first time, an occurrence of the identified event at the information handling system; and
in response to detecting the occurrence of the identified event, allocating the particular neural hardware resources to the client for execution of the particular model.

16. The non-transitory computer-readable medium of claim 15, the operations further including:
de-registering, after execution of the particular model, the triggering condition.

17. The non-transitory computer-readable medium of claim 15, the operations further including:
receiving, from the client, a query for the data indicating the identified neural hardware resources and the identified events; and
in response to receiving the query, providing, to the client, the data indicating the identified neural hardware resources and the identified events.

18. The non-transitory computer-readable medium of claim 15, the operations further including:
in response to detecting the occurrence of the identified event:
configuring the particular neural hardware resources; and
allocating the particular neural hardware resources to the client.

19. The non-transitory computer-readable medium of claim 15, wherein the events supported at the information handling system include system-level events, application-level events, and firmware-level events.

20. The non-transitory computer-readable medium of claim 15, wherein the neural hardware resources of the information handling system includes neural processing unit (NPU), graphics processing unit (GPU), and gaussian and neural accelerator (GNA).
